(19) United States
(12) Patent Application Publication
(10) Pub. No.: US 2019/0236621 A1
(43) Pub. Date: Aug. 1, 2019

(54) SYSTEMS AND METHODS FOR OPTIMIZING CONTENT VARIATIONS

(71) Applicant: WAL-MART STORES, INC., Bentonville, AR (US)

(72) Inventors: Chenxi Liu, Santa Clara, CA (US); Lu Wang, Sunnyvale, CA (US); Wei Shen, Danville, CA (US)

(73) Assignee: WAL-MART STORES, INC., Bentonville, AR (US)

(21) Appl. No.: 15/883,849

(22) Filed: Jan. 30, 2018

(51) Int. Cl. G06Q 30/02; H04L 12/58; G06Q 10/10; G06F 17/18

(52) U.S. Cl. CPC G06Q 30/0203; G06F 17/18; G06Q 10/107; H04L 51/04

(57) ABSTRACT

Systems and methods including one or more processors and one or more non-transitory computer-readable media having computing instructions that are configured to run on the one or more processors and perform acts of creating content variations for including in initial communications to initial targets, the content variations each comprising one or more content items selected from content item options, setting weightings for the content item options, transmitting the initial communications comprising the content variations to the initial targets, receiving initial response information, determining whether a minimum level of statistically significant difference is achieved between responses, determining updated weightings of the first and second ones of the content item options in relation to the initial response information, and transmitting updated communications comprising the content variations to subsequent targets. Additional embodiments are disclosed herein.

### TECHNICAL FIELD

This disclosure relates generally to systems and methods for optimizing content variations including a plurality of content item options.

### BACKGROUND

The optimization of content provided in communications such as email is increasingly important in retail environments, to engage persons receiving the communications with the end goal of eliciting a response. However, effective engagement of persons can depend on picking the content items such as subject lines and content modules that are most likely to be interesting and attractive to such persons. Because it can be difficult to assess in advance how responsive persons will be, such messages may be sent with a few different content variations, in the hopes that at least some of the content variations will be effective in eliciting a response. However, as some of the content variations may be less efficient in eliciting a response than others, such a process may not be optimal in obtaining responses from all persons receiving the communications.

### BRIEF DESCRIPTION OF THE DRAWINGS

To facilitate further description of the embodiments, the following drawings are provided in which:

FIG. 1 illustrates a front elevational view of a computer system that is suitable for implementing various embodiments of the systems disclosed in FIGS. 3 and 5;

FIG. 2 illustrates a representative block diagram of an example of the elements included in the circuit boards inside a chassis of the computer system of FIG. 1;

FIG. 3 illustrates a representative block diagram of a system, according to an embodiment;

FIG. 4 is a flowchart for a method, according to certain embodiments;

FIG. 5 illustrates a representative block diagram of a portion of the system of FIG. 3, according to an embodiment; and

FIG. 6 is a flowchart for a method, according to certain embodiments.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

A number of embodiments can include a system. The system can include one or more processors, and one or more non-transitory computer-readable media storing computing instructions configured to run on the one or more processors. The one or more non-transitory computer-readable media can be configured to run on the one or more processors and perform acts of creating content variations for including in initial communications to initial targets, the content variations each comprising one or more content items selected from content item options, setting weightings for the content item options included in the content variations, the weightings corresponding to first relative fractions of the initial communications in which each of the content item options are included in a content variation; transmitting the initial communications comprising the content variations to the initial targets, with the first relative fractions of the initial communications in which each of the content item options are included in a content variation of the content variations being set according to the weightings for each of the content item options, receiving initial response information in relation to initial responses of the initial targets to the initial communications, determining, in relation to the initial response information, whether a minimum level of statistically significant difference is achieved between responses to a first portion of the initial communications having a first one of the content variations with a first one of the content item options as compared to a second portion of the initial communications having a second one of the content variations with a second one of the content item options, when the minimum level of statistically significant difference is achieved, determining updated weightings of the first and second ones of the content item options in relation to the initial response information, for a portion of the initial response information received in a first predetermined period of time, and transmitting updated communications comprising the content variations to subsequent targets, with second relative fractions of the updated communications in which the first and second ones of the content item options are included in a content variation being set according to the updated weightings for each of the first and second content item options.

Various embodiments include a method. The method can be implemented via execution of computing instructions configured to run at one or more processors and configured to be stored at non-transitory computer-readable media. The method can include creating content variations for including in communications to targets, the content variations each comprising one or more content items selected from content item options. The method can also include setting weightings for the content item options included in the content variations, the weightings corresponding to relative fractions of the communications in which each of the content item options are included in a content variation. The method can also include transmitting initial communications comprising the content variations to the targets, with the relative fractions of the communications in which each of the content item options are included in a content variation being set according to the weightings for each of the content item options. The method can also include receiving response information in relation to responses of the targets to the initial communications. The method can also include determining, in relation to the response information, whether a minimum level of statistically significant difference is achieved between responses to initial communications having a first content variation having a first content item option as compared to initial communications having a second content variation having a second content item option. The method can also include, if the minimum level of statistically significant difference is achieved, determining updated weightings of the first and second content items options in relation to the response information, for response information received in a predetermined period of time. The method can also include transmitting updated communications comprising the content variations to subsequent targets, with the relative fractions of the updated communications in which the first and second content item options are included in a content variation being set according to the updated weightings for each of the first and second content item options.

Various embodiments include a method. The method can be implemented via execution of computing instructions configured to run at one or more processors and configured to be stored at non-transitory computer-readable media. The method can include creating content variations for including in communications to targets in response to a trigger event, the content variations each comprising one or more content items selected from content item options. The method can also include setting weightings for the content item options included in the content variations, the weightings corresponding to relative fractions of the communications in which each of the content item options are included in a content variation. The method can also include receiving response information in relation to responses by the targets to communications transmitted to the targets in response to the trigger event, the communications comprising the content variations, with the relative fractions of the communications in which each of the content item options are included in a content variation being set according to the weightings for each of the content item options. The method can also include determining, in relation to the response information, whether a minimum level of statistically significant difference is achieved between responses to communications having a first content variation having a first content item option as compared to communications having a second content variation having a second content item option. The method can also include, if the minimum level of statistically significant difference is achieved, determining updated weightings of the first and second content items options in relation to the response information, for response information received in a predetermined period of time.

Email communications have been an increasingly important and effective marketing channel for communicating with current and potential customers of retailers. To efficiently engage customers using email campaigns, it can be important for marketing engineers to pick the best variations in content items including the email subject line and content modules.

Email campaigns can be roughly divided into at least two types: one-time batch campaigns and recurring trigger campaigns. For batch campaigns, emails are sent at a specific time to a specific set of customers only once. Batch campaigns are usually associated with a large size of recipients. The process of sending all the batch emails in the sending application often takes several hours. According to one embodiment, the relatively long time span of the sending process can offer opportunities for optimizing subject line and content modules in real time. That is, in certain embodiments, a given initial batch of emails can be sent evenly across different variations (e.g., subject line and/or content module). According to certain aspects, as response data is collected (e.g., open, click, etc.) in real time, the feedback data can be evaluated to influence the allocation of email variations sent out later.

Compared to batch campaigns, the scheduling of recurring trigger campaigns can be more complicated. In certain embodiments, trigger campaigns are scheduled once or multiple times daily, based on trigger events such as abandoning a shopping cart, a price drop of an item, expiration of a time window post-browsing, etc. Due to the relative sparsity of trigger events, each batch of trigger campaign emails is typically relatively small and does not take much time to send, as compared to a batch campaign. The total number of trigger emails sent typically depends on the number of trigger events, and thus typically is not predefined. Furthermore, within one send period, the difference in response data can be disproportionately affected by random noise, rather than reflecting any true underlying difference among the variations in terms of response. As a result, in certain embodiments, the same real-time subject line and content module optimization approach for batch email campaigns is not directly applicable to recurring trigger campaigns.

According to one embodiment, a near real-time robust optimization (RO) approach can be provided for optimizing content items such as subject lines and content modules in recurring trigger email campaigns. According to certain embodiments, the RO approach leverages statistical hypothesis testing over accumulated response data from multiple batches. According to certain aspects, although each batch of sends for trigger campaigns is small, a nice feature of trigger campaign is that it is recurring and may be running for several months. Accordingly, in certain embodiments, the RO approach can start from an even distribution of email variations, and as response data is collected for the same type of triggers across several days, statistical hypothesis testing can be run to see if the difference in responses across different variations is statistically significant. If the difference is significant, then according to certain aspects the accumulated response data generated up to that point is used to optimize the allocation of email variations for the next small batch. Furthermore, in some embodiments, to ensure that the response data is up to date, a sliding time window is used for collecting response data. Even further, according to certain embodiments, whenever there are changes in the content such as the subject line or content modules, the entire optimization process is re-initialized. Finally, the accumulated impact across multiple days can be used to report response lift against the evenly distribution baseline to ensure performance stability.

According to one embodiment, compared to the baseline scenario of distributing all email variations evenly, this near real-time robust optimization approach is capable of converging to the best email variation and can lead to 10% to 20% response lift. Because it is automatically adaptive to any changes in content such as subject line and content modules, it significantly reduces time and effort for marketing engineers to perform AB testing to find the best email variation.

Details of methodology and implementation of this approach, according to certain embodiments, is discussed below.

According to one embodiment, the following robust optimization problem is formulated to generate the optimal allocation of traffic across p email variations of a recurring trigger campaign.

Let r be the reward vector (e.g., click rate or open rate) to represent the metrics with the objective function E[rewards]=rⱼNⱼ+ . . . +rₚNₚ. The decision variables vector wᵢ represents the ratio of email sends that is allocated for variation i, i.e., wᵢ=Nᵢ/Σᵢ₌₁^{p}Nᵢ.

The optimization formulation according to one embodiment is as follows:

$${max}_{{\sum }_{i} {w}_{i} = 1 , {w}_{i} \geq 0} {min}_{r ∈ U} {r}^{T} w$$

where U={r|∥r−r̅∥₂≤ρ};

p>0 is a scalar describing the size of perturbation;

Nᵢ is the number of emails sent with variation i and weight wᵢ;

Σᵢ₌₁^{p}Nᵢ is the total number of emails sent; and

p is the total number of variations.

According to one embodiment, at a given time t, the metrics r are obtained, and the optimal solution w* to the above robust optimization problem is obtained. The weights can be updated as new metrics come in.

To decide when to let the optimization kick in, according to certain embodiments, statistical hypothesis testing can be used to compare the metrics. For example, taking rates of opening email messages as an example, it can be assumed among all the variations that the highest and lowest open rates have O₁, O₂ opens and N₁, N₂ sends, respectively. A two-sample proportion test can be used to compare the difference with a test statistic:

$$Z = \frac{\frac{{O}_{1}}{{N}_{1}} - \frac{{O}_{2}}{{N}_{2}}}{\sqrt{\hat{p} ( 1 - \hat{p} ) ( \frac{1}{N} - \frac{1}{{N}_{2}} )}} , where \hat{p} = \frac{{O}_{1} + {O}_{2}}{{N}_{1} + {N}_{2}} .$$

According to one embodiment, the updating of the weights starts only after a statistically significant difference is found between the variations. In certain embodiments, to overcome the day-of-week bias, a rolling 7-day window is used to calculate the metrics.

Further aspects of embodiments of the implementation are described. In one embodiment, an example of a recurring trigger email campaign can have 3 candidate subject lines (denoted as s1, s2, s3 in the following description) and 2 email content modules (denoted as m1, m2). In this example, the campaign has been scheduled daily and will run for several months. In the process of this campaign, customers' response data is collected, and testing traffic is robustly allocated to winners.

In this example, the number of email sends for different subject lines and content module combinations are evenly distributed, and customers' open/click data is collected for optimization. For example, ⅓ is assigned as the weight to s1, s2, s3 individually, and ½ is assigned as the weight for m1, m2. Accordingly, in total there are 3*2 combinations of subject lines and content modules (s1m1, s2m1, s3m1, s1m2, s2m2, s3m2), and each of them will have ⅙ of the total number of sends.

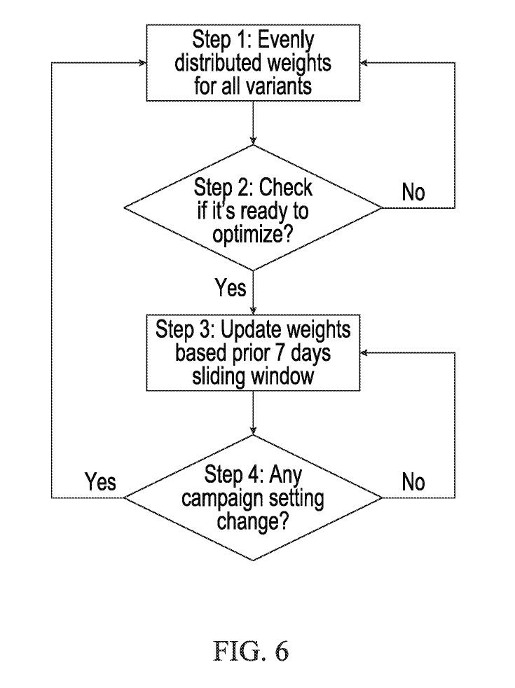

An exemplary flow chart illustrating steps according to an embodiment is shown in FIG. 6. According to this embodiment, Step 1 as shown comprises sending out emails with the variations, with evenly distributed weights for all variations. Step 2 comprises, for the evenly distributed setting, checking to see if a statistically significant difference is achieved to allow for optimization based on currently collected accumulated click and send data. According to one aspect, subject lines and content modules will be checked individually. In one embodiment, if the campaign is not ready to optimize (No at Step 2), optimization is delayed for at least one more day, at which point Steps 1 and 2 are repeated. If the campaign is ready to optimize (Yes at Step 2), then, the weights for each subject line and content module are updated, so that the sends can be distributed according to the weights for the different subject line and content module combinations in the upcoming campaign process. In Step 3, the weights are updated based on a 7-day moving window of accumulated click and send data prior to the current date. The weights can be updated daily if appropriate according to Step 2. In certain embodiments, data collected prior to the 7-day time window are not considered, in order to ensure the weights represent the most up-to-date customer behaviors. According to one embodiment, depending on the resulting weights, lower weighted (i.e. losing) subject lines and content modules can be manually identified with new candidates, as in Step 4. If such a new campaign setting change occurs, then the process goes back to Step 1 (Yes at Step 4), and the new campaign is re-started with evenly distributed weights. If no campaign setting change occurs (No at Step 4), then the weights are continuously updated based on the 7-day sliding window.

According to one embodiment, because the campaign will last for a range of days and optimization is run based on the accumulated sliding window's data, click lift calculation of only one day is not appropriate for our optimization performance. Furthermore, in certain embodiments, after the campaign is optimized, some variations might have only a very small number of sends, such as several hundreds or even less than 100. However, the total number of sends for the entire campaign on a current date, or for several days, might be several hundred thousand. The click rate based on such a small number of sends might not be representative, and thus, the click rate based on only the current batch for current date is not enough in some embodiments. Accordingly, in one embodiment, the accumulated data from the sliding window prior to the current date is reported.

According to one embodiment, the average click rate of the accumulated 7-day sliding window is calculated for each variation, and compared with the total average click rate. Then, the click lift for each variation can be calculated, along with the click lift of the total campaign.

Further discussion of aspects of the model, as well as embodiments of systems and methods that can incorporate the model or at least a portion thereof, are described below.

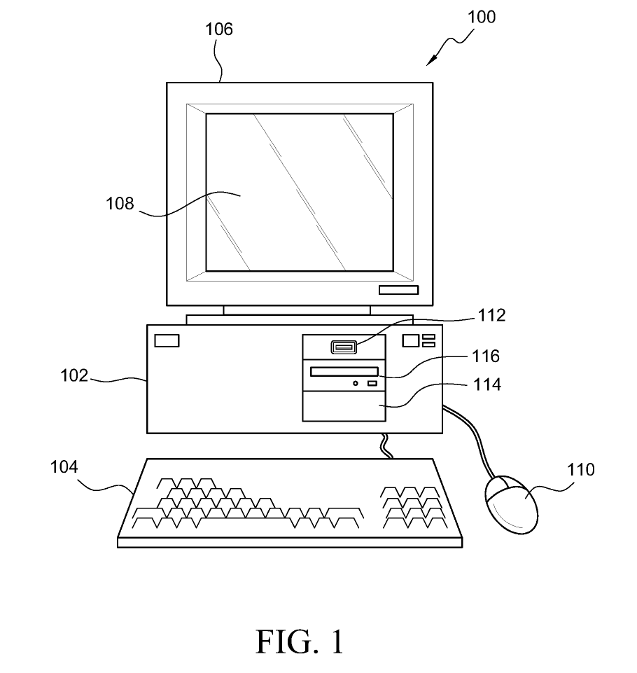

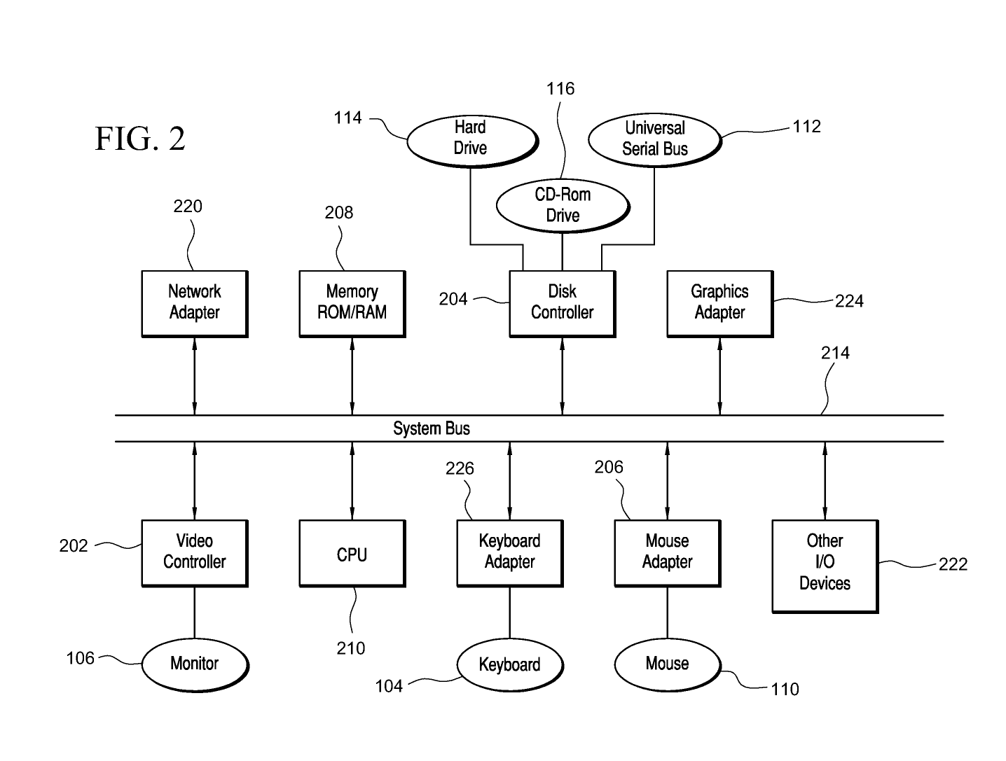

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the memory storage modules described herein. As an example, a different or separate one of a chassis 102 (and its internal components) can be suitable for implementing part or all of one or more embodiments of the techniques, methods, and/or systems described herein. Furthermore, one or more elements of computer system 100 (e.g., a monitor 106, a keyboard 104, and/or a mouse 110, etc.) also can be appropriate for implementing part or all of one or more embodiments of the techniques, methods, and/or systems described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 can comprise (i) non-volatile memory, such as, for example, read only memory (ROM) and/or (ii) volatile memory, such as, for example, random access memory (RAM). The non-volatile memory can be removable and/or non-removable non-volatile memory. Meanwhile, RAM can include dynamic RAM (DRAM), static RAM (SRAM), etc. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. In these or other embodiments, memory storage unit 208 can comprise (i) non-transitory memory and/or (ii) transitory memory.

In various examples, portions of the memory storage module(s) of the various embodiments disclosed herein (e.g., portions of the non-volatile memory storage module(s)) can be encoded with a boot code sequence suitable for restoring computer system 100 (FIG. 1) to a functional state after a system reset. In addition, portions of the memory storage module(s) of the various embodiments disclosed herein (e.g., portions of the non-volatile memory storage module(s)) can comprise microcode such as a Basic Input-Output System (BIOS) operable with computer system 100 (FIG. 1). In the same or different examples, portions of the memory storage module(s) of the various embodiments disclosed herein (e.g., portions of the non-volatile memory storage module(s)) can comprise an operating system, which can be a software program that manages the hardware and software resources of a computer and/or a computer network. The BIOS can initialize and test components of computer system 100 (FIG. 1) and load the operating system. Meanwhile, the operating system can perform basic tasks such as, for example, controlling and allocating memory, prioritizing the processing of instructions, controlling input and output devices, facilitating networking, and managing files. Exemplary operating systems can comprise one of the following: (i) Microsoft® Windows® operating system (OS) by Microsoft Corp. of Redmond, Wash., United States of America, (ii) Mac® OS X by Apple Inc. of Cupertino, Calif., United States of America, (iii) UNIX® OS, and (iv) Linux® OS. Further exemplary operating systems can comprise one of the following: (i) the iOS® operating system by Apple Inc. of Cupertino, Calif., United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, Calif., United States of America, (v) the Windows Mobile™ operating system by Microsoft Corp. of Redmond, Wash., United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processing modules of the various embodiments disclosed herein can comprise CPU 210.

Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs. In many embodiments, an application specific integrated circuit (ASIC) can comprise one or more processors or microprocessors and/or memory blocks or memory storage.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

Network adapter 220 can be suitable to connect computer system 100 (FIG. 1) to a computer network by wired communication (e.g., a wired network adapter) and/or wireless communication (e.g., a wireless network adapter). In some embodiments, network adapter 220 can be plugged or coupled to an expansion port (not shown) in computer system 100 (FIG. 1). In other embodiments, network adapter 220 can be built into computer system 100 (FIG. 1). For example, network adapter 220 can be built into computer system 100 (FIG. 1) by being integrated into the motherboard chipset (not shown), or implemented via one or more dedicated communication chips (not shown), connected through a PCI (peripheral component interconnector) or a PCI express bus of computer system 100 (FIG. 1) or USB port 112 (FIG. 1).

Returning now to FIG. 1, although many other components of computer system 100 are not shown, such components and their interconnection are well known to those of ordinary skill in the art. Accordingly, further details concerning the construction and composition of computer system 100 and the circuit boards inside chassis 102 are not discussed herein.

Meanwhile, when computer system 100 is running, program instructions (e.g., computer instructions) stored on one or more of the memory storage module(s) of the various embodiments disclosed herein can be executed by CPU 210 (FIG. 2). At least a portion of the program instructions, stored on these devices, can be suitable for carrying out at least part of the techniques and methods described herein.

Further, although computer system 100 is illustrated as a desktop computer in FIG. 1, there can be examples where computer system 100 can take a different form factor while still having functional elements similar to those described for computer system 100. In some embodiments, computer system 100 can comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 can comprise a portable computer, such as a laptop computer. In certain other embodiments, computer system 100 can comprise a mobile electronic device, such as a smartphone. In certain additional embodiments, computer system 100 can comprise an embedded system.

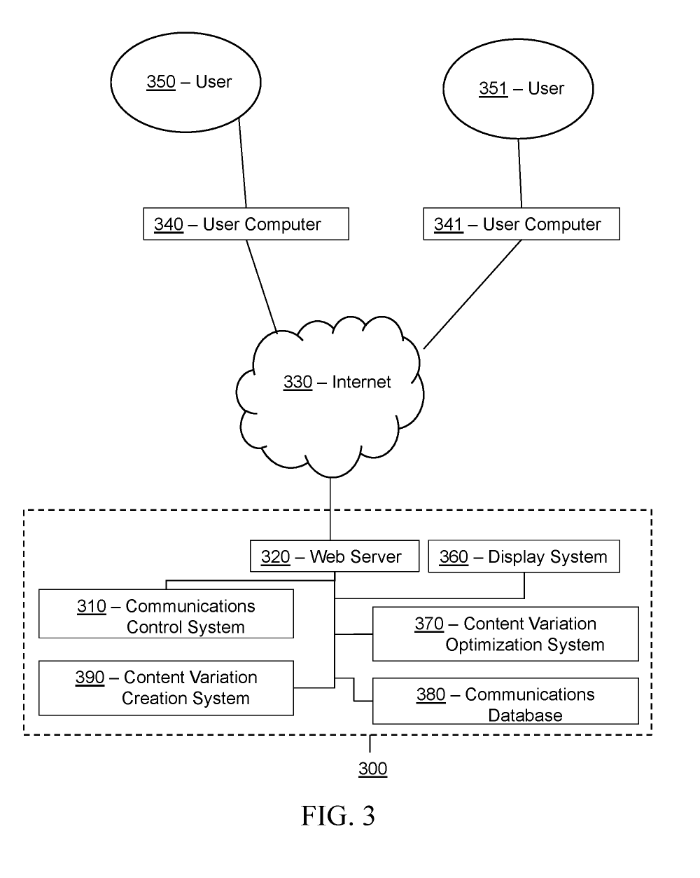

Turning ahead in the drawings, FIG. 3 illustrates a block diagram of a system 300 that can be employed for optimizing content variations in communications, as described in greater detail below. System 300 is merely exemplary and embodiments of the system are not limited to the embodiments presented herein. System 300 can be employed in many different embodiments or examples not specifically depicted or described herein. In some embodiments, certain elements or modules of system 300 can perform various procedures, processes, and/or activities. In these or other embodiments, the procedures, processes, and/or activities can be performed by other suitable elements or modules of system 300.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In some embodiments, system 300 can include a communications control system 310, a web server 320 (or front end server), a display system 360, a content variation optimization system 370, a content variation creation system 390, and/or communications database 380. Communications control system 310, web server 320, display system 360, content variation optimization system 370, content variation creation system 390, and/or communications database 380 can each be a computer system, such as computer system 100 (FIG. 1), as described above, and can each be a single computer, a single server, or a cluster or collection of computers or servers, or a cloud of computers or servers. In another embodiment, a single computer system can host each of two or more of communications control system 310, web server 320, display system 360, content variation optimization system 370, content variation creation system 390, and/or communications database 380. Additional details regarding communications control system 310, web server 320, display system 360, content variation optimization system 370, content variation creation system 390, and/or communications database 380 are described herein.

In many embodiments, system 300 also can comprise user computers 340, 341. User computers 340, 341 can comprise any of the elements described in relation to computer system 100. In some embodiments, user computers 340, 341 can be mobile devices. A mobile electronic device can refer to a portable electronic device (e.g., an electronic device easily conveyable by hand by a person of average size) with the capability to present audio and/or visual data (e.g., text, images, videos, music, etc.). For example, a mobile electronic device can comprise at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile electronic device can comprise a volume and/or weight sufficiently small as to permit the mobile electronic device to be easily conveyable by hand. For examples, in some embodiments, a mobile electronic device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile electronic device can weigh less than or equal to 15.6 Newtons, 17.8 Newtons, 22.3 Newtons, 31.2 Newtons, and/or 44.5 Newtons.

Exemplary mobile electronic devices can comprise (i) an iPod®, iPhone®, iTouch®, iPad®, MacBook® or similar product by Apple Inc. of Cupertino, Calif., United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile electronic device can comprise an electronic device configured to implement one or more of (i) the iPhone® operating system by Apple Inc. of Cupertino, Calif., United States of America, (ii) the Blackberry® operating system by Research In Motion (RIM) of Waterloo, Ontario, Canada, (iii) the Palm® operating system by Palm, Inc. of Sunnyvale, Calif., United States, (iv) the Android™ operating system developed by the Open Handset Alliance, (v) the Windows Mobile™ operating system by Microsoft Corp. of Redmond, Wash., United States of America, or (vi) the Symbian™ operating system by Nokia Corp. of Keilaniemi, Espoo, Finland.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can comprise a mobile electronic device, and vice versa. However, a wearable user computer device does not necessarily comprise a mobile electronic device, and vice versa.

In specific examples, a wearable user computer device can comprise a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can comprise (i) Google Glass™ product or a similar product by Google Inc. of Menlo Park, Calif., United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M100™ product, or a similar product by Vuzix Corporation of Rochester, N.Y., United States of America. In other specific examples, a head mountable wearable user computer device can comprise the Virtual Retinal Display™ product, or similar product by the University of Washington of Seattle, Wash., United States of America. Meanwhile, in further specific examples, a limb mountable wearable user computer device can comprise the iWatch™ product, or similar product by Apple Inc. of Cupertino, Calif., United States of America, the Galaxy Gear or similar product of Samsung Group of Samsung Town, Seoul, South Korea, the Moto 360 product or similar product of Motorola of Schaumburg, Ill., United States of America, and/or the Zip™ product, One™ product, Flex™ product, Charge™ product, Surge™ product, or similar product by Fitbit Inc. of San Francisco, Calif., United States of America.

In some embodiments, web server 320 can be in data communication through Internet 330 with user computers (e.g., 340, 341). In certain embodiments, user computers 340-341 can be desktop computers, laptop computers, smart phones, tablet devices, and/or other endpoint devices. Web server 320 can host one or more websites and/or can provide services as an email server. For example, web server 320 can host a website that allows users to browse and/or search for products, to add products to an electronic shopping cart, and/or to purchase products, in addition to other suitable activities. Web server also can serve as an email server to send and receive email messages via the internet 330 to user computers (e.g., 340, 341).

In many embodiments, communication control system 310, web server 320, display system 360, content variation optimization system 370, content variation creation system 390, and/or communications database 380 can each comprise one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to the processing module(s) and/or the memory storage module(s) communications control system 310, web server 320, display system 360, content variation optimization system 370, content variation creation system 390, and/or communications database 380 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processing module(s) and/or the memory storage module(s). In some embodiments, the KVM switch also can be part of communications control system 310, web server 320, display system 360, content variation optimization system 370, content variation creation system 390, and/or communications database 380. In a similar manner, the processing module(s) and the memory storage module(s) can be local and/or remote to each other.

In many embodiments, communications system 310, web server 320, display system 360, content variation optimization system 370, content variation creation system 390, and/or communications database 380 can be configured to communicate with one or more user computers 340 and 341. In some embodiments, user computers 340 and 341 also can be referred to as customer computers and/or target computers. In some embodiments, communications system 310, web server 320, display system 360, content variation optimization system 370, content variation creation system 390, and/or communications database 380 can communicate or interface (e.g., interact) with one or more customer computers and/or target computers (such as user computers 340 and 341) through a network or internet 330. Internet 330 can be an intranet that is not open to the public. Accordingly, in many embodiments, communications system 310, web server 320, display system 360, content variation optimization system 370, content variation creation system 390, and/or communications database 380 (and/or the software used by such systems) can refer to a back end of system 300 operated by an operator and/or administrator of system 300, and user computers 340 and 341 (and/or the software used by such systems) can refer to a front end of system 300 used by one or more users 350 and 351, respectively. In some embodiments, users 350 and 351 also can be referred to as customers, viewers and/or targets, in which case, user computers 340 and 341 can be referred to as customer computers, viewer computers, and/or target computers. In these or other embodiments, the operator and/or administrator of system 300 can manage system 300, the processing module(s) of system 300, and/or the memory storage module(s) of system 300 using the input device(s) and/or display device(s) of system 300.

Meanwhile, in many embodiments, communications system 310, web server 320, display system 360, content variation optimization system 370, content variation creation system 390, and/or communications database 380 also can be configured to communicate with one or more databases or electronic file management systems. The one or more databases can comprise a product database that contains information about products, items, or SKUs (stock keeping units) sold by a retailer. The one or more databases can be stored on one or more memory storage modules (e.g., non-transitory memory storage module(s)), which can be similar or identical to the one or more memory storage module(s) (e.g., non-transitory memory storage module(s)) described above with respect to computer system 100 (FIG. 1). Also, in some embodiments, for any particular database of the one or more databases, that particular database can be stored on a single memory storage module of the memory storage module(s), and/or the non-transitory memory storage module(s) storing the one or more databases or the contents of that particular database can be spread across multiple ones of the memory storage module(s) and/or non-transitory memory storage module(s) storing the one or more databases, depending on the size of the particular database and/or the storage capacity of the memory storage module(s) and/or non-transitory memory storage module(s).

The one or more databases or electronic file management systems can each comprise a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communication between communications control system 310, web server 320, display system 360, content variation optimization system 370, content variation creation system 390, and/or communications database 380 and/or the one or more databases or electronic file management systems can be implemented using any suitable manner of wired and/or wireless communication. Accordingly, system 300 can comprise any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can comprise Bluetooth, Zigbee, Wireless Universal Serial Bus (USB), Z-Wave, etc.; exemplary LAN and/or WAN protocol(s) can comprise Institute of Electrical and Electronic Engineers (IEEE) 802.3 (also known as Ethernet), IEEE 802.11 (also known as WiFi), etc.; and exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can comprise wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can comprise wireless communication hardware including, for example, one or more radio transceivers, one or more infrared transceivers, etc. Additional exemplary communication hardware can comprise one or more networking components (e.g., modulator-demodulator components, gateway components, etc.).

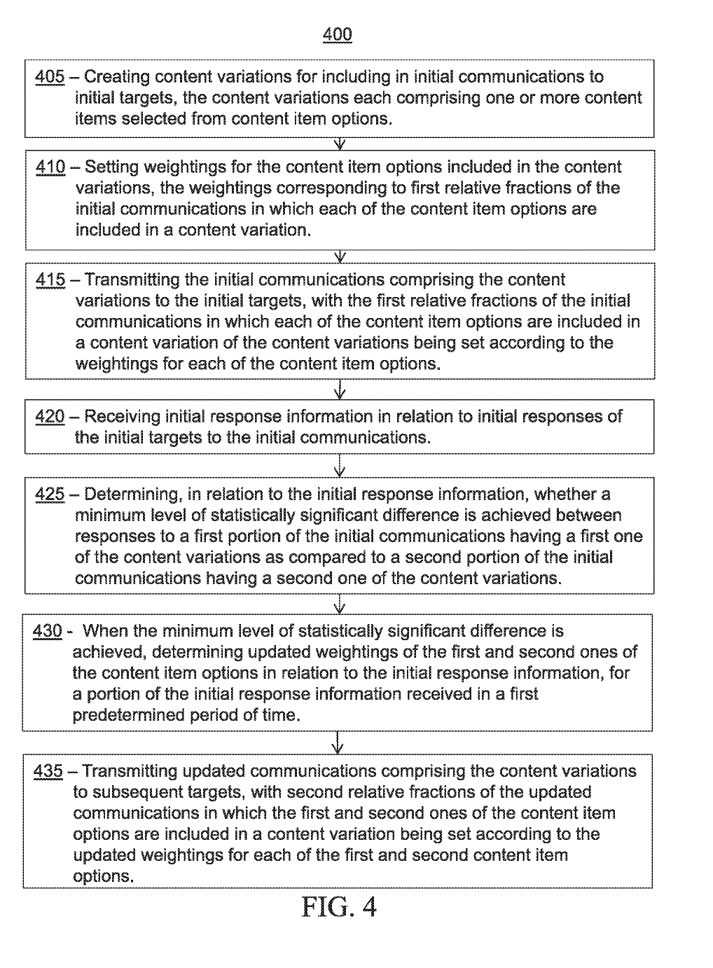

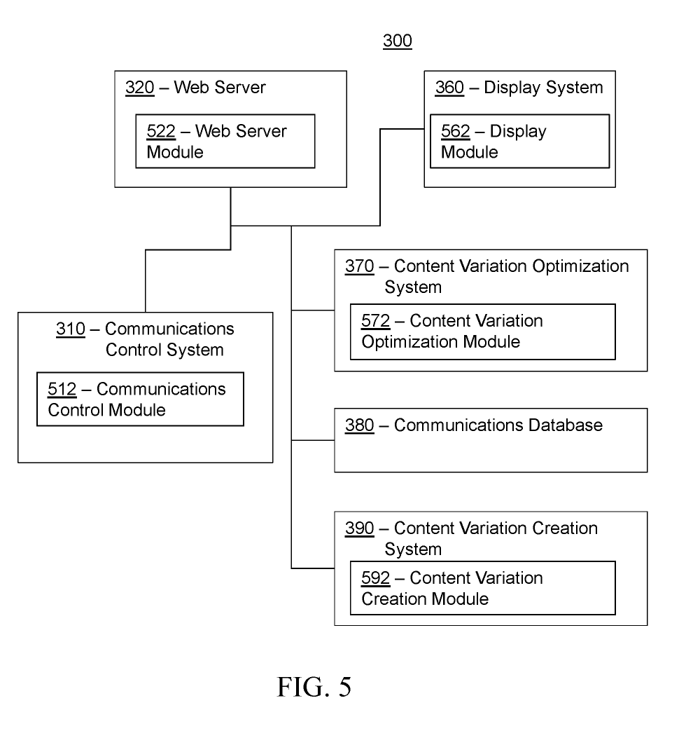

Turning ahead in the drawings, FIG. 4 illustrates a flow chart for a method 400, according to an embodiment. Method 400 is merely exemplary and is not limited to the embodiments presented herein. Method 400 can be employed in many different embodiments or examples not specifically depicted or described herein. In some embodiments, the activities of method 400 can be performed in the order presented. In other embodiments, the activities of method 400 can be performed in any suitable order. In still other embodiments, one or more of the activities of method 400 can be combined or skipped. In many embodiments, system 300 (FIG. 3) can be suitable to perform method 400 and/or one or more of the activities of method 400. In these or other embodiments, one or more of the activities of method 400 can be implemented as one or more computer instructions configured to run at one or more processing modules and configured to be stored at one or more non-transitory memory storage modules 512, 562, 572 and/or 592 (FIG. 5). Such non-transitory memory storage modules can be part of a computer system such as communications control system 310, web server 320, display system 360, content variation optimization system 370, content variation creation system 390, and/or communications database 380 (FIGS. 3 & 5). The processing module(s) can be similar or identical to the processing module(s) described above with respect to computer system 100 (FIG. 1).

In many embodiments, method 400 can comprise an activity 405 of creating content variations for including in initial communications to initial targets, where the content variations each comprise one or more content items selected from content item options. In some embodiments, activity 405 can comprise creating, at a first processor, such as but not limited to the content variation creation system 390 (FIG. 3), one or more content items from content item options provide by the communications database 380, which can be used to create a plurality of content variations for communications to the targets. The communications can be, for example, at least one of email messages, text messages, instant messages, or other types of electronic communications.

The targets can correspond to users 350, 351 (FIG. 3), and can be targeted via the user computers 340, 341 (FIG. 3), such as users 350, 351 (FIG. 3) that are customers or potential customers of a retailer, and/or persons that have expressed interest in a retail item. For example, in certain embodiments the targets are users 350, 351 (FIG. 3) that entered items into a shopping cart online, but ended their browsing session without purchase. As yet another example, the targets in certain embodiments are users 350, 351 (FIG. 3) that have viewed certain items and/or a retailer's site online, but that have not returned to the retailer's online site for a predetermined window of time. As yet another example, the target in certain embodiments can be a user 350, 351 (FIG. 3) that has a predetermined relationship with an item (such as having viewed the item online, or having purchased quantities of the item in the past), which item has experienced a recent change such as a change in price, availability (e.g., stock is running low or stock has been replenished) and/or popularity (e.g., has been the subject of recent promotions), etc. For example, the targets can be users 350, 351 (FIG. 3) that have expressed interest in an item, such as by viewing an item on a retailer's online site, and which item has dropped in price or is the subject of a promotion that can be of interest to the target. In certain embodiments, the targets are users 350, 351 (FIG. 3) that a retailer wishes to communicate with to provide information or reminders, in the hopes the target will respond by visiting the retailer's online site or otherwise following up on the information. In some embodiments, the communications are a part of a trigger email campaign, where email messages are triggered individually for each target, based on the target's activities and/or changes in items they have expressed an interest in, such as any of those discussed above.

In one embodiment, the activity 405 comprises creating the content variations for including in the initial communications to the initial targets, by creating content variations that each comprise content categories, where each content category of the content categories comprises the one or more content items that can be selected from the content item options for each respective category of the content categories, and where the content item options comprise one or more first category item options for a first category of the content categories, and one of more second category item options for a second category of the content categories. That is, according to one embodiment, the content variation creation system 390 (FIG. 3) receives one or more content items from the communications database 380 (FIG. 3) that are selected from among various options in one or a plurality of different content categories. The communication database 380 (FIG. 3) can store, for example, content items belonging to only a single category, or can store content items for several different categories, meaning that the options for the content items used in the content variations can be options selected from different categories (or, in certain other embodiments, options from only a single category). In one embodiment, the content variation creation system 390 (FIG. 3) receives from the communication database 380 (FIG. 3) content items from at least two different categories, such as the first and second categories, which are used by the content variation creation system 390 (FIG. 3) in creating the content variations that include content items from both categories. For example, for a communication database 390 (FIG. 3) containing content item options for a first category A and a second category B, the content variation creation system 390 (FIG. 3) can receive content items A1, A2 and A3 as content options from the first category, and content items B1 and B2 as the content options from the second category. In certain embodiments, the content variation creation system 390 (FIG. 3) combines the received content items from each category with content items from one or more other categories, in different combinations, to create the content variations. For example, the content variation creation system 390 (FIG. 3) can combine content items from the first category A1, A2, A3 with content items from the second category B1, B2, to create the plurality of content variations A1B1, A1B2, A2B1, A2B2, A3B1 and A3B2, with each content variation containing one content item selected from the first content category A, and one content item selected from the second content category B. Further categories of content items, such as three, four and even more categories of content items, can be similarly combined to create the content variations.

In one embodiment, the content categories in the content variations include one or more different fields of the communications to the targets, such subjects fields for subjects of the communications, and body fields for bodies of the communications, and where the content item options include subject item options for the subjects of the communications and body module item options for the bodies of the communications. That is, in some embodiments, the communications database 380 (FIG. 3) can comprise content item options in categories that correspond to different fields contained in a communication, such as different email message fields, and which can include subject options for a subject field of a communication, and body options for a body field of a communication. Options for other message fields also can be stored. Accordingly, in certain embodiments, the content variation creation system 390 (FIG. 3) receives subject options for a subject field of the communications, and body options for a body field of the communications, from the communications database 380 (FIG. 3), and combines the subject options with the body options to create content variations having different combinations of the subject and body. That is, in certain embodiments, the content variations can provide different combinations of message subject content and message body content, for providing in communications to the targets. In addition and/or alternatively, the content categories include in the content variations can include other fields other than those specifically mentioned, and can include other categories such as images, as well as sub-categories of certain categories such as content options for different sections of a body field of a message (e.g., greeting section, main message section, signature section, etc.)

In many embodiments, method 400 can comprise an activity 410 of setting weightings for the content item options included in the content variations, the weightings corresponding to first relative fractions of the initial communications in which each of the content item options are included in a content variation. That is, in some embodiments, activity 410 can comprise, at a first processor, such as but not limited to the content variation creation system 390 (FIG. 3) performing calculations or otherwise assigning weightings by which each of the content item options are included in a content variation. In one embodiment, the activity 410 comprises setting the weightings for the content item options such that each possible combination of the content item options in the content variations is included at a same rate in the initial communications. For example, for content variations comprising two categories A and B, with three content options A1, A2 and A3 for category A, and two content options B1 and B2, the weightings for each content option A1, A2, A3, B1 and B2 are set such that each combination making up a content variation has the same overall weight, meaning in this case for each of the content variations A1B1, A1B2, A2B1, A2B2, A3B1 and A3B2, each content variation will be included in ⅙ of the communications (i.e., each A option is weighted as ⅓, and each B option is weighted ½, to provide the six equally weighted combinations). Alternatively, in certain embodiments it is contemplated that the weightings can be set to include certain combinations at a higher rate. However, for initial communications being sent for the purposes of determining an optimal content variation, in certain embodiments an equal weighting for each combination of the content variations can provide an improved baseline from which to assess optimal target response to the variations.

In several embodiments, method 400 can comprise an activity 415 of transmitting the initial communications comprising the content variations to the initial targets, with the first relative fractions of the initial communications in which each of the content item options are included in a content variation of the content variations being set according to the weightings for each of the content item options. That is, according to one embodiment, the activity 415 can comprise receiving, at a first processor, such as but not limited to the communications control system 310 (FIG. 3), the content variations and respective weightings from the content variation control system 390 (FIG. 3). The activity 415 can also comprise receiving, at a first processor, such as but not limited to the communications control system 310 (FIG. 3), a list of targets for the communications from the communications database 380 (FIG. 3). For example, the communications database 380 (FIG. 3) can provide a list of targets identified for a trigger campaign, or targets that have otherwise been identified for the communications. In some embodiments, the communications control system 310 (FIG. 3) works in conjunction with the webserver 320 (FIG. 3) to transmit the initial communications to the targets (e.g., users 350, 351 (FIG. 3)) via the internet 330 (FIG. 3).

In certain embodiments, the activity 415 comprises controlling the fraction of communications that contain each content variation in relation to the weightings set for each content item option, such as via the communications control system 310 (FIG. 3). For example, in certain embodiments, to establish a baseline, the content item options can be weighted so that each content variation appears in the same relative fraction of communications as the other content variations being sent in the communications. In one embodiment, the activity 415 comprises transmitting the initial communications in response to one or more triggers comprising one or more of an action of one or more of the initial targets, and a change in state of an item associated with one of more of the initial targets. That is, in certain embodiments, the initial communications can be triggered for sending to the initial targets by any of the triggers described above, such as abandonment of an online cart by a target, a lapse in visits to an online site by a target, a change in price or availability of an item believed to be of interest to a target, and other triggers. Furthermore, in certain embodiments, the initial communications can be continued to be sent for each subsequent trigger that occurs. For example, in one embodiment transmitting the initial communications in response to the one or more triggers comprises transmitting a first set of the initial communications in response to a first trigger that occurs at a first point in time, and transmitting a second set of initial communications in response to a second trigger that occurs after the first trigger. The first and second trigger can be, for example, of the same trigger type, or can be different types of triggers. For example in one embodiment the first and second set of initial communications are sent to targets in response to the same type of trigger, such as an abandoned online cart left by the targets, for each day that the trigger event occurs. In another embodiment, the first and second triggers can be of different trigger types, such as a first trigger corresponding to an abandoned cart, and a second trigger corresponding to a price drop of an item. In certain embodiments, optimization of content variations for each of the triggers can then be separately evaluated, and/or the content variations can be optimized for both triggers. In certain embodiments, content variations are selected with specificity for a particular trigger. Accordingly, in certain embodiments it can be advantageous to optimize with respect to a single trigger type, in which case the first and second triggers can be selected to be of the same trigger type.

In several embodiments, method 400 can comprise an activity 420 of receiving initial response information in relation to initial responses of the initial targets to the initial communications. That is, according to one embodiment, the activity 420 can comprise receiving, at a first processor, such as but not limited to the web server 320, the initial response information corresponding to the initial target responses. In certain embodiments, activity 420 can comprise receiving the initial response information in relation to one or more of a rate at which the initial targets have opened and/or viewed the initial communications, and a rate at which the initial targets execute actions in response to receiving the initial communications. For example, the response information can include information that indicates, for each content variation, how many communications sent with the content variation were opened and/or viewed by the targets. The response information can also include information that indicates, for example, for each content variation, how many communications elicited a response from their targets such as opening a link included in the communication, visiting an online site referred to in the communication, target inquiries regarding information in the communication, etc.

In various embodiments, method 400 can comprise an activity 425 of determining, in relation to the initial response information, whether a minimum level of statistically significant difference is achieved between responses to a first portion of the initial communications having a first one of the content variations with a first one of the content item options as compared to a second portion of the initial communications having a second one of the content variations with a second one of the content item options. That is, the activity 425 can comprise determining whether a statistically significant difference is achieved between different content variations having different content item options, for the initial communications. According to one embodiment, the activity 425 can comprise receiving at a first processor, such as but not limited to the content variation optimization system 370 (FIG. 3), the initial response information as gathered by the web server 320 (FIG. 3), and using this information to assess whether a minimum level of statistically significant difference has been achieved between the content variations for the response information received at that time point. Furthermore, the activity 425 can further comprise determining whether the minimum level of statistically significant difference is achieved between responses to a portion of the initial communications having two or more of the first one of the content variations with the first one of the content item options and a third one of the content variations with a third one of the content item options, as compared to responses to the second portion of the initial communications having the second one of the content variations with the second one of the content item options. That is, according to some embodiments, the statistical significance of any different response to the initial communications can be determined as between any two or more, and even all content variations, and their constituent content items.

In certain embodiments, the activity 425 comprises determining, in relation to the initial response information, whether the minimum level of statistically significant difference is achieved between responses to the first portion of the initial communications having the first one of the content variations with the first one of the content item options as compared to the second portion of the initial communications having the second one of the content variations with the second one of the content item options, by determining a statistical difference according to a two-sample proportion test:

$$Z = \frac{\frac{{O}_{1}}{{N}_{1}} - \frac{{O}_{2}}{{N}_{2}}}{\sqrt{\hat{p} ( 1 - \hat{p} ) ( \frac{1}{N} - \frac{1}{{N}_{2}} )}} , where \hat{p} = \frac{{O}_{1} + {O}_{2}}{{N}_{1} + {N}_{2}}$$

where
Z is a measure of the statistical difference;
O₁ represents a rate of response by the initial targets to the initial communications having the first one of the content variations with the first one of the content item options;
O₂ represents a rate of response by the initial targets to the initial communications having the second one of the content variations with the second one of the content item options;
N₁ represents a number of the initial communications sent to the initial targets having the first one of the content variations with the first one of the content item options; and

N₂ represents a number of the initial communications sent to the initial targets having the second one of the content variations with the second one of the content item options,

and after determining the statistical difference, comparing Z to a baseline level to determine whether the minimum level is achieved.

Furthermore, in certain embodiments, when the minimum level of statistically significant difference is determined by performing activity 425 to not have been achieved, then method 400 returns to activity 420, which is continued to be performed for continuing to receive the initial response information in relation to the initial responses of the initial targets to the initial communications, until it is determined by performing activity 425 that the minimum level of statistically significant difference is achieved.

In several embodiments, when the minimum level of statistically significant difference is achieved as determined by activity 425, the method 400 can comprise the activity 430 of determining updated weightings of the first and second ones of the content item options in relation to the initial response information, for a portion of the initial response information received in a first predetermined period of time. According to one embodiment, the activity 430 can comprise at a first processor, such as but not limited to the content variation optimization system 370 (FIG. 3), performing calculations to determine the updated weightings. For example, in certain embodiments, the weightings can be updated such that content item options that received an increased response from the targets are weighted more highly than content item options receiving less response. Furthermore, the first predetermined period of time can comprise, in certain embodiments, a time period corresponding to a period in which response information is received that is considered in determining the updated weightings. That is, in certain embodiments, the updated weightings are determined using only certain response information corresponding to information received in the predetermined period of time, with response information received outside this period of time not being considered in determining the updated weightings. In one embodiment, the activity 430 comprises determining the updated weightings using the initial response information received over the 7 days immediately preceding a current day on which determination of the updated weightings is performed. Furthermore, in alternative embodiments, other predetermined periods of time can be used, such as predetermined periods of time where it is expected that targets will be motivated to provide a response, or where it is believed that response rates will accurately reflect the effectiveness of the content variations in generating responses.

According to some embodiments, the activity 430 comprises determining the updated weightings of the first and second ones of the content item options in relation to the initial response information, for the portion of the initial response information received in the first predetermined period of time, where determining the updated weightings can be accomplished by obtaining a solution w* to an optimization formula:

$${max}_{{\sum }_{i} {w}_{i} = 1 , {w}_{i} \geq 0} {min}_{r ∈ U} {r}^{T} w$$

where U={r|∥r−r̅∥₂≤ρ};
ρ>0 is a scalar;
r is a vector related to a rate of response by the initial targets to the initial communications with an objective function E[r]=R₁N₁+ . . . +RₚNₚ;
wᵢ represents a ratio of the initial communications transmitted for each content variation i, where wᵢ=Nᵢ/Σᵢ₌₁^{p}Nᵢ;
Nᵢ represents a number of communications sent with content variation i and weight wᵢ;
Σᵢ₌₁^{p}Nᵢ is the total number of communications sent; and
p is the total number of variations.

In several embodiments, the method 400 can comprise the activity 435 of transmitting updated communications comprising the content variations to subsequent targets, with second relative fractions of the updated communications in which the first and second ones of the content item options are included in a content variation being set according to the updated weightings for each of the first and second content item options. That is, in certain embodiments, the updated weightings determined in activity 430 can be used to set the relative fractions of content item options in subsequently sent communications, such that content options that elicited increased response rates can be emphasized over content item options that did not elicit as strong a response. For example, for content item options having an increased response, the number of communications sent with content variations including the content item options, can make up a larger fraction of the total number of communications sent as compared to the number of communications sent with content variations including content item options that exhibited a lesser response. Accordingly, in certain aspects, the updated communications are optimized as compared to the initial communications, in that the content being provided in the messages is weighted towards that content that elicited an increased response. According to one embodiment, the activity 430 can comprise receiving, at a first processor, such as but not limited to the communications control system 310 (FIG. 3), the updated weightings for each of the first and second content item options from the content variation optimization system 370 (FIG. 3). In certain embodiments, the communications control system 310 (FIG. 3) also can receive information about the subsequent targets, such as a list of subsequent targets, from the communications database 380 (FIG. 3). The communications control system 310 (FIG. 3) can work in conjunction with the web server 320 (FIG. 3), in certain embodiments, to transmit the updated communications to the subsequent targets, with the second relative fractions of the updated communications being set according to the updated weightings. In one embodiment, the subsequent targets can comprise one or more of the initial targets, such as all of the initial targets. In yet another embodiment, the subsequent targets comprise targets other than the initial targets. That is, the targets for the updated communications can be the same as the original targets, and/or can comprise different targets than those receiving the initial communications.

In yet another embodiment, the method 400 can further comprise performing activities of receiving subsequent response information in relation to subsequent responses of the subsequent targets to the updated communications, determining updated weightings of the first and second ones of the content item options in relation to the subsequent response information received from the subsequent targets to the updated communications, for a portion of the subsequent response information received in a second predetermined period of time, and transmitting further updated communications according to the updated weightings to further targets. In one embodiment, the further targets comprise one or more of the updated targets and initial targets, such as all of the updated and initial targets. In yet another embodiment, the further targets comprise targets other than the updated and initial targets. That is, the targets for the further updated communications can be the same as the original targets and/or updated targets, and/or can comprise different targets than those receiving the initial communications and/or the first updated communications. According to one embodiment, the receiving of the subsequent response information, determining the updated weightings, and transmitting the further updated communications can correspond to repeating the activities 420, 430, and 435, using the subsequent response information instead of the initial response information for 420 and 430, and transmitting the further updated communications in 435 using the updated weighting as determined using this subsequent response information.

In yet another embodiment, the method 400 can further comprise performing activities of changing one or more of the content item options to an updated content item option, in response to the updated weightings, and in response to changing to the updated content item option, setting further updated weightings for the content item options, transmitting further communications comprising the content variations including the updated content item option to further targets, receiving further response information in relation to further responses of the further targets to the further communications, determining whether the minimum level of statistically significant difference is achieved for the further responses to the further communications, when the minimum level of statistically significant difference is achieved for the further responses to the further communications, determining additionally updated weightings for the one or more content items comprising the updated content item option, and transmitting additional communications comprising the content variations including the updated content item to additional targets, wherein the additional communications are based at least in part on the additionally updated weightings for the one or more content items. That is, in certain embodiments, the weightings determined for the content items can indicate that a particle one of the content item options is performing poorly compared to others. In such a situation, in certain embodiment, a decision can be made to manually or otherwise replace the content item option with a new content item option that has not yet been transmitted as a part of a content variation (or has been transmitted as a different category in a content variation). That is, the method 400 can comprise performing activity 405, but where the content variations are being created with at least one updated content item, for sending in further communications to further targets. In one embodiment, the further targets comprise one or more of the initial targets and subsequent targets, and in another embodiment the further targets comprise new targets that are other than the initial and subsequent targets. Once the content item option is changed, some embodiments involve repeating the activities 410, 420, 430, and 435, using the updated content items and variations created therewith, including setting further updated weightings (which in certain embodiments can involve setting evenly distributed weightings to establish a baseline), transmitting further communications with the updated content item, receiving further response information in relation to the updated content items, determining whether statistical significance is achieved, determining additionally updated weightings, and transmitting additional communications with the updated content item having the additionally updated weighting, wherein the additional communications are based at least in part on the additionally updated weightings. That is, once a new content item is introduced into the content variations, the method 400 can be repeated to determine the weighting optimizations for the new content variations with the updated content item.

FIG. 5 illustrates a block diagram of a portion of system 300 comprising communications control service system 310, web server 320, display system 360, content variation optimization system 370, content variation creation system 390 and/or communications database 380, according to the embodiment shown in FIG. 3. Each of communications control system 310, web server 320, display system 360, content variation optimization system 370, content variation creation system 390 and/or communications database 380 in FIG. 5 is merely exemplary and not limited to the embodiments presented herein. Each of communications control system 310, web server 320, display system 360, content variation optimization system 370, content variation creation system 390 and/or communications database 380, can be employed in many different embodiments or examples not specifically depicted or described herein. In some embodiments, certain elements or modules of communications control system 310, web server 320, display system 360, content variation optimization system 370, content variation creation system 390 and/or communications database 380 can perform various procedures, processes, and/or acts. In other embodiments, the procedures, processes, and/or acts can be performed by other suitable elements or modules.

In many embodiments, communications control system 310 can comprise non-transitory memory storage module 512. Memory storage module 512 can be referred to as communications control module 512. In many embodiments, communications control module 512 can store computing instructions configured to run on one or more processing modules and perform one or more acts of method 400 (FIG. 4). For example, in some embodiments, the communications control module 512 creates communications such as email messages, and/or works with web server 320 to provide information to users 350, 351 regarding items or other information.

In many embodiments, web server 320 can comprise non-transitory memory storage module 522. Memory storage module 522 can be referred to as web server module 522. In many embodiments, web server module 522 can store computing instructions configured to run on one or more processing modules and perform one or more acts of method 400 (FIG. 4) (e.g., activity 415 of transmitting the initial communications comprising the content variations to the initial targets (FIG. 4), activity 420 of receiving initial response information in relation to initial response of the initial targets to the initial communications (FIG. 4), and activity 435 of transmitting updated communications comprising the content variations to subsequent targets (FIG. 4)).

In many embodiments, display system 360 can comprise non-transitory memory storage module 562. Memory storage module 562 can be referred to as display module 562. In many embodiments, display module 562 can store computing instructions configured to run on one or more processing modules and perform one or more acts of method 400 (FIG. 4). In some embodiments, the display module 562 operates in conjunction with the communications control system 310 (FIG. 3) to communicate information regarding items to a user 350, 351 (FIG. 3), for example via a web page hosted by the web server 320 and broadcast to the user 350, 351 (FIG. 3) via the internet 330 (FIG. 3).

In many embodiments, content variation optimization system 370 can comprise non-transitory memory storage module 572. Memory storage module 572 can be referred to as content variation optimization module 572. In many embodiments, content variation optimization module 572 can store computing instructions configured to run on one or more processing modules and perform one or more acts of method 400 (FIG. 4) (e.g. an activity 425 of determining, in relation to initial response information, whether a minimal level of statistically significant difference is achieved (FIG. 4), and an activity 430 of, when a minimum level of statistically significant difference is achieved, determining updated weightings (FIG. 4)).

In many embodiments, content variation creation system 390 can comprise non-transitory memory storage module 572. Memory storage module 572 can be referred to as content variation creation module 592. In many embodiments, content variation creation module 572 can store computing instructions configured to run on one or more processing modules and perform one or more acts of method 400 (FIG. 4) (e.g. an activity 405 of creating content variations for including in the initial communications (FIG. 4), and an activity 410 of setting weightings for the content item options (FIG. 4)).

In many embodiments, communications database 380 can store computing instructions configured to run on one or more processing modules and perform one or more acts of method 400 (FIG. 4) (e.g. an activity of providing a list of targets as initial or subsequent targets for receiving the initial or subsequent communications, and an activity or providing content item options for creating the content variations.

Although systems and methods for optimizing content variations for communications to targets have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-6 may be modified, and that the foregoing discussion of certain of these embodiments does not necessarily represent a complete description of all possible embodiments. For example, one or more of the procedures, processes, or activities of FIG. 4 may include different procedures, processes, and/or activities and be performed by many different modules, in many different orders.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

1. A system, comprising:
one or more processors; and
one or more non-transitory computer-readable media storing computing instructions configured to run on the one or more processors and perform acts of;
creating content variations for including in initial communications to initial targets, the content variations each comprising one or more content items selected from content item options;
setting weightings for the content item options included in the content variations, the weightings corresponding to first relative fractions of the initial communications in which each of the content item options are included in a content variation;
transmitting the initial communications comprising the content variations to the initial targets, with the first relative fractions of the initial communications in which each of the content item options are included in a content variation of the content variations being set according to the weightings for each of the content item options;
receiving initial response information in relation to initial responses of the initial targets to the initial communications;
determining, in relation to the initial response information, whether a minimum level of statistically significant difference is achieved between responses to a first portion of the initial communications having a first one of the content variations with a first one of the content item options as compared to a second portion of the initial communications having a second one of the content variations with a second one of the content item options;
when the minimum level of statistically significant difference is achieved, determining updated weightings of the first and second ones of the content item options in relation to the initial response information, for a portion of the initial response information received in a first predetermined period of time; and
transmitting updated communications comprising the content variations to subsequent targets, with second relative fractions of the updated communications in which the first and second ones of the content item options are included in a content variation being set according to the updated weightings for each of the first and second content item options.

2. The system of claim 1, wherein:
creating the content variations for including in the initial communications to the initial targets, comprises:
creating the content variations with content categories, where each content category of the content categories comprises the one or more content items that can be selected from the content item options for each respective category of the content categories, and
the content item options comprise: one or more first category item options for a first category of the content categories; and one of more second category item options for a second category of the content categories.

3. The system of claim 2, wherein:
the content categories in the content variations comprise: subject fields for subjects of the initial and updated communications; and body fields for bodies of the initial and updated communications; and
the content item options comprise: subject item options for the subjects of the initial and updated communications; and body module item options for the bodies of the initial and updated communications.

4. The system of claim 1, wherein setting the weightings for the content item options included in the content variations, the weightings corresponding to the first relative fractions of the initial communications in which each of the content item options are included in at least one content variation, comprises:
setting the weightings for the content item options such that each possible combination of the content item options in the content variations is included at a same rate in the initial communications.

5. The system of claim 1, wherein determining, in relation to the initial response information, whether the minimum level of statistically significant difference is achieved between responses to the first portion of the initial communications having the first one of the content variations with the first one of the content item options as compared to the second portion of the initial communications having the second one of the content variations with the second one of the content item options, further comprises:
determining whether the minimum level of statistically significant difference is achieved between responses to a portion of the initial communications having two or more of the first one of the content variations with the first one of the content item options and a third one of the content variations with a third one of the content item options, as compared to responses to the second portion of the initial communications having the second one of the content variations with the second one of the content item options.

6. The system of claim 1, wherein transmitting the initial communications comprising the content variations to the initial targets, with the first relative fractions of the initial communications in which each of the content item options are included in the content variation of the content variations being set according to the weightings for each of the content item options, comprises:
transmitting the initial communications in response to one or more triggers comprising one or more of:
an action of one or more of the initial targets; and
a change in state of an item associated with one or more of the initial targets.

7. The system of claim 6, wherein transmitting the initial communications in response to the one or more triggers comprises:
transmitting a first set of the initial communications in response to a first trigger; and
transmitting a second set of the initial communications in response to a second trigger that occurs after the first trigger.

8. The system of claim 1, wherein the one or more non-transitory computer-readable media storing computing instructions are further configured to run on the one or more processors and perform acts of:
receiving subsequent response information in relation to subsequent responses of the subsequent targets to the updated communications;
determining updated weightings of the first and second ones of the content item options in relation to the subsequent response information received from the subsequent targets to the updated communications, for a portion of the subsequent response information received in a second predetermined period of time; and
transmitting further updated communications according to the updated weightings to further targets.

9. The system of claim 1, wherein determining the updated weightings of the first and second ones of the content item options in relation to the initial response information, for the portion of the initial response information received in the first predetermined period of time, comprises:
determining the updated weightings using the initial response information received over 7 days immediately preceding the determining of the updated weightings.

10. The system of claim 1, further configured to perform an act of:
when the minimum level of statistically significant difference is not achieved, continuing to receive the initial response information in relation to the initial responses of the initial targets to the initial communications, until it is determined that the minimum level of statistically significant difference is achieved.

11. The system of claim 1, further configured to perform acts of:
changing one or more of the content item options to an updated content item option, in response to the updated weightings; and
in response to changing to the updated content item option:
setting further updated weightings for the content item options;
transmitting further communications comprising the content variations including the updated content item option to further targets;
receiving further response information in relation to further responses of the further targets to the further communications;
determining whether the minimum level of statistically significant difference is achieved for the further responses to the further communications;
when the minimum level of statistically significant difference is achieved for the further responses to the further communications, determining additionally updated weightings for the one or more content items comprising the updated content item option; and
transmitting additional communications comprising the content variations including the updated content item to additional targets, wherein the additional communications are based at least in part on the additionally updated weightings for the one or more content items.

12. The system of claim 1, wherein receiving the initial response information in relation to the initial responses of the initial targets to the initial communications, comprises:
receiving the initial response information in relation to one or more of:
a rate at which the initial targets have opened the initial communications, and
a rate at which the initial targets execute actions in response to receiving the initial communications.

13. The system of claim 1, wherein determining, in relation to the initial response information, whether the minimum level of statistically significant difference is achieved between responses to the first portion of the initial communications having the first one of the content variations with the first one of the content item options as compared to the second portion of the initial communications having the second one of the content variations with the second one of the content item options, comprises:
determining a statistical difference according to a two-sample proportion test:
$$Z = \frac{\frac{{O}_{1}}{{N}_{1}} - \frac{{O}_{2}}{{N}_{2}}}{\sqrt{\hat{p} ( 1 - \hat{p} ) ( \frac{1}{N} - \frac{1}{{N}_{2}} )}} , where \hat{p} = \frac{{O}_{1} + {O}_{2}}{{N}_{1} + {N}_{2}} .$$
where
Z is a measure of the statistical difference,
O₁ represents a rate of response by the initial targets to the initial communications having the first one of the content variations with the first one of the content item options,
O₂ represents a rate of response by the initial targets to the initial communications having the second one of the content variations with the second one of the content item options,
N₁ represents a number of the initial communications sent to the initial targets having the first one of the content variations with the first one of the content item options; and
N₂ represents a number of the initial communications sent to the initial targets having the second one of the content variations with the second one of the content item options; and
comparing Z to a baseline level to determine whether the minimum level is achieved.

14. The system according to claim 1, wherein determining the updated weightings of the first and second ones of the content item options in relation to the initial response information, for the portion of the initial response information received in the first predetermined period of time, comprises:
determining the updated weightings by obtaining a solution w* to an optimization formula:
$${max}_{{\sum }_{i} {w}_{i} = 1 , {w}_{i} \geq 0} {min}_{r ∈ U} {r}^{T} w$$
where U={r|∥r−r̅∥₂≤ρ}, ρ>0 is a scalar;
r is a vector related to a rate of response by the initial targets to the initial communications with an objective function E[r]=R₁N₁+ . . . +RₚNₚ;
wᵢ represents a ratio of the initial communications transmitted for each content variation i, where wᵢ=Nᵢ/Σᵢ₌₁^{p}Nᵢ;
Nᵢ represents a number of communications sent with content variation i and weight wᵢ;
Σᵢ₌₁^{p}Nᵢ is the total number of communications sent; and
p is the total number of variations.

15. A method being implemented via execution of computing instructions configured to run at one or more processors and configured to be stored at a non-transitory computer-readable media, the method comprising:
creating content variations for including in initial communications to targets, the content variations each comprising one or more content items selected from content item options;
setting weightings for the content item options included in the content variations, the weightings corresponding to first relative fractions of the initial communications in which each of the content item options are included in a content variation;
transmitting initial communications comprising the content variations to the initial targets, with the first relative fractions of the initial communications in which each of the content item options are included in a content variation being set according to the weightings for each of the content item options;
receiving initial response information in relation to initial responses of the initial targets to the initial communications;
determining, in relation to the initial response information, whether a minimum level of statistically significant difference is achieved between responses to a first portion of the initial communications having a first one of the content variations with a first one of the content item option as compared to a second portion of the initial communications having a second one of the content variations with a second one of a the content item option;
when the minimum level of statistically significant difference is achieved, determining updated weightings of the first and second ones of the content item options in relation to the initial response information, for a portion of the initial response information received in a first predetermined period of time; and
transmitting updated communications comprising the content variations to subsequent targets, with second relative fractions of the updated communications in which the first and second ones of the content item options are included in a content variation being set according to the updated weightings for each of the first and second content item options.

16. The method of claim 15, wherein creating the content variations for including in communications to the targets, comprises:
creating the content variations with content categories comprising: subject fields for subjects of the initial and updated communications; and body fields for bodies of the initial and updated communications, and
the content item options comprise: subject item options for the subjects of the initial and updated communications; and body module item options for the bodies of the initial and updated communications.

17. The method of claim 15, wherein transmitting initial communications comprising the content variations to the targets, with the first relative fractions of the communications in which each of the content item options are included in the content variation of the content variations being set according to the weightings for each of the content item options, comprises:
transmitting the initial communications in response to one or more triggers comprising one or more of an action of one or more of the initial targets and a change in state of an item associated with one or more of the targets.

18. The method of claim 15, wherein determining updated weightings of the first and second ones of the content items options in relation to the initial response information, for the portion of the initial response information received in the first predetermined period of time, comprises:
determining the updated weightings using the initial response information received over 7 days immediately preceding determining of the updated weightings.

19. The system of claim 15, wherein receiving the initial response information in relation to the initial responses of the initial targets to the initial communications, comprises:
receiving the initial response information in relation to one or more of a rate at which the initial targets have opened the initial communications, and a rate at which the initial targets execute actions in response to receiving the initial communications.

20. A method being implemented via execution of computing instructions configured to run at one or more processors and configured to be stored at a non-transitory computer-readable media, the method comprising:
creating content variations for including in initial communications to initial targets in response to a trigger event, the content variations each comprising one or more content items selected from content item options;
setting weightings for the content item options included in the content variations, the weightings corresponding to first relative fractions of the initial communications in which each of the content item options are included in a content variation;
receiving initial response information in relation to initial responses of the initial targets to the initial communications transmitted to the initial targets in response to the trigger event, the initial communications comprising the content variations, with the first relative fractions of the initial communications in which each of the content item options are included in a content variation being set according to the weightings for each of the content item options;
determining, in relation to the initial response information, whether a minimum level of statistically significant difference is achieved between responses to a first portion of the initial communications having a first one of the content variations with a first one of the content item options as compared to a second portion of the initial communications having a second one of the content variations with a second one of the content item options; and
when the minimum level of statistically significant difference is achieved, determining updated weightings of the first and second ones of the content items options in relation to the initial response information, for a portion of the initial response information received in a first predetermined period of time.
